(19) United States
(12) Patent Application Publication
(10) Pub. No.: US 2010/0101931 A1
(43) Pub. Date: Apr. 29, 2010

(54) PROCESS FOR PREPARING VERY PURE 1,4-BUTANEDIOL

(75) Inventors: Rolf Pinkos, Bad Duerkheim (DE); Rudolf Erich Lorenz, Lambsheim (DE); York Alexander Beste, Pahang (MY)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/524,790

(22) PCT Filed: Mar. 14, 2007
(86) PCT No.: PCT/EP2007/052418

§ 371 Date: Jul. 28, 2009

(30) Foreign Application Priority Data
Feb. 15, 2007 (EP) 07102474.9

(51) Int. Cl. B01D 3/14

(52) U.S. Cl. 203/82

(57) ABSTRACT

The present invention provides a process for distillatively purifying crude aqueous 1,4-butanediol (1), in which 1,4-butanediol (5) freed of components having lower boiling points than 1,4-butanediol and water is passed through three distillation columns (III, IV, V), components having a higher boiling point than 1,4-butanediol are drawn off from the bottom of the first column and conducted into the third (7), 1,4-butanediol from the top of the first column (6) is conducted into the second, the bottom product of the second column (9) is conducted into the third, the top product of the third column (11) is recycled at least partly into the first column, wherein the very pure 1,4-butanediol is withdrawn from a side draw of the second column.

The invention relates to a continuous process for distillatively purifying 1,4-butanediol (BDO).

The preparation of 1,4-butanediol by reacting acetylene with formaldehyde and subsequent catalytic hydrogenation of the resulting 1,4-butynediol is a reaction which has been known for many years.

The preparation of 1,4-butanediol by hydrogenating 1,4-butynediol affords a crude product which, in addition to 1,4-butanediol, may comprise water, methanol, propanol, butanol, gamma-butyrolactone, 2-methyl-1,4-butanediol, 1,4-butanediol, 2-(4-hydroxybutoxy)tetrahydrofuran (referred to hereinafter as acetal), pentanediols, for example 1,5-pentanediol and 2-methyl-1,5-pentanediol, salts, organic high boilers and also further, quantitatively insignificant secondary components.

For the recovery of pure 1,4-butanediol from such crude products, DE-A 2 055 892 discloses a process for distillatively purifying crude aqueous 1,4-butanediol, in which the 1,4-butanediol, after removal of water and low boilers in two distillation stages, is passed through three further distillation columns, the top product of the third column being passed into a fourth column from which pure 1,4-butanediol is obtained as the bottom product. The bottom product of the third column, which comprises low-purity 1,4-butanediol and constituents having higher boiling points than 1,4-butanediol (high boilers), is conducted into a fifth column, where it is separated into low-purity 1,4-butanediol and high boilers. The relatively low-purity butanediol is recycled into the third column.

Although the aqueous crude products obtainable by hydrogenating 1,4-butynediol are purified by the process known from DE-A 2 055 892 in order to be able to be used in common further processing of 1,4-butanediol, for example to obtain polyesters or polyurethanes, a higher purity is required in applications in which the requirements on the butanediol are particularly high, for example in order to obtain particularly high molecular weights in the case of polyester.

It is therefore an object of the invention to find an improved process which enables the purification of crude 1,4-butanediol products in an economically viable manner and which allows a product particularly suitable for polyester or polyurethane preparation to be prepared.

This object is achieved by a process for distillatively purifying crude aqueous 1,4-butanediol (1) in which 1,4-butanediol (5) freed of components having lower boiling points than 1,4-butanediol (low boilers) and water is passed through three distillation columns (III, IV, V), components having higher boiling points than 1,4-butanediol (high boilers) are drawn off from the bottom of the first column (III) and conducted into column (V) (7), 1,4-butanediol is conducted from the top of the first column (III) (6) into the second column (IV), the bottom product of the second column (IV) (9) is conducted into the third column (V), the top product of the third column (V) (11) is recycled at least partly into the first column (III), wherein the pure 1,4-butanediol (10) is withdrawn from a side draw of the second column (IV).

The process according to the invention can be applied to crude aqueous 1,4-butanediol which has been obtained by a wide variety of different preparation processes. It is particularly suitable for crude 1,4-butanediol products which have arisen by hydrogenation of 1,4-butynediol. It enables highly pure 1,4-butanediol to be obtained.

In the novel process, the distillative purification of the crude aqueous 1,4-butanediol, which has preferably been obtained by hydrogenating 1,4-butynediol, after the removal, which is known per se, of the low boilers and of the water in columns (I) and (II) is undertaken in three columns connected in series (III, IV, V) in such a way as is evident from the figure.

The product stream which stems from the hydrogenation of the 1,4-butynediol is typically, directly after the hydrogenation, passed into a separator in which gas phase and liquid phase separate. The gas phase comprises predominantly hydrogen. When hydrogenation is effected with cycle gas, this separator is preferably operated at the same pressure as the hydrogenation itself in order that the gas withdrawn therefrom need not additionally be compressed. A portion of the gas stream can be disposed of as offgas.

The liquid phase of the separator can be passed through a decompression valve into a further gas, liquid separator or directly into the distillation unit. In both cases, dissolved gas, predominantly hydrogen, is discharged and preferably incinerated, which can generate energy.

The pressure after the decompression is generally between standard pressure and 20 bar, preferably between standard pressure and 15 bar, more preferably between standard pressure and 10 bar.

The product stream of the hydrogenation (1) which is obtained after substantial removal of the hydrogen comprises generally methanol, propanol, butanol, water, gamma-butyrolactone, 2-methyl-1,4-butanediol, 1,4-butanediol, 2-(4-hydroxybutoxy)tetrahydrofuran (referred to hereinafter as acetal), pentanediols, for example 1,5-pentanediol and 2-methyl-1,5-pentanediol, salts, organic high boilers and further, quantitatively insignificant secondary components. The temperatures of the distillations described below are determined by the vapor pressures of the components present in the streams and the pressure established. The distillations preferably run with thermal integration, in order to consume a minimum amount of energy.

For the distillative purification of the crude aqueous 1,4-butanediol (1), preference is given to using a plurality of columns as distillation units. In the present application, columns or distillation units are understood to mean column types known per se, for example rectification columns equipped as packed columns, tray columns with sieve trays, dual-flow trays, bubble-cap trays, valve trays, dividing wall columns or thin-film or falling-film evaporators.

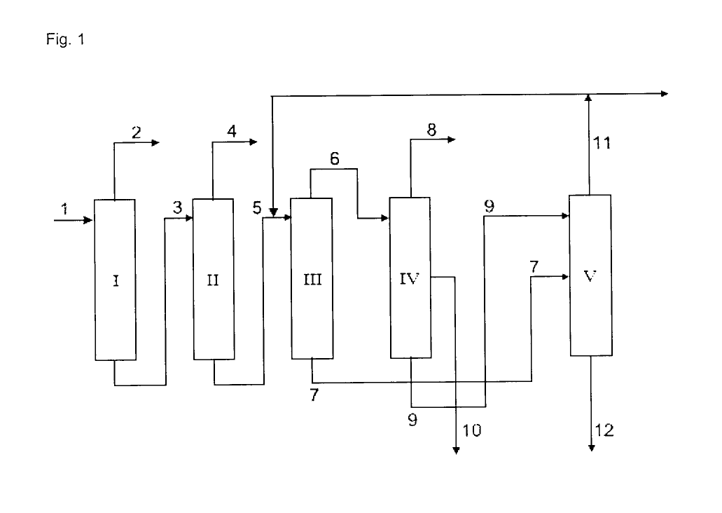

Low boilers such as methanol, propanol, butanol and water are removed from the crude aqueous 1,4-butanediol-containing product stream (1) at pressures (absolute) between 0.5 and 20 bar, preferably between 0.8 and 10 bar. This removal can be effected in at least one distillation column. Preference is given to effecting the removal in at least two distillation columns, in which case a mixture of methanol, propanol and butanol which also comprises water is distilled off in the first column (I). In a further column (II) or a plurality of further columns, more preferably two further columns which preferably have thermal integration, the remaining water is distilled off. The stream (2) comprising methanol, propanol and butanol and also water can either be incinerated or separated separately into the individual components, in order to use them, for example, as solvents in other processes. Methanol can, for example, be used in formaldehyde preparation. Stream 2 is preferably separated in such a way that methanol is distilled off via the top in a further column not shown in FIG. 1, and a mixture of propanol, butanol and water is removed via a side draw. The mixture is preferably cooled to such an extent that it divides into two phases, and the upper phase which comprises predominantly butanol and propanol can be discharged and either separated further or incinerated, while the lower phase which comprises predominantly water can be released into the wastewater or be recycled into the column, and the bottom stream obtained is predominantly water.

The bottom product (3) is then fed to the column (II), from which water can be drawn off as the top product (4) and prepurified crude butanediol as the bottom product (5).

The product stream (5) obtained after the distillative removal of the water and low boilers comprises, as well as up to 99.8% by weight of 1,4-butanediol and also gammabutyrolactone, 2-methyl-1,4-butanediol, acetal, pentanediols, salts, organic high boilers and further, quantitatively insignificant secondary components, and is worked up further by distillation.

According to FIG. 1, the product stream (5) is separated in column (III) into top fraction (6) which comprises volatile organic constituents and comprises from 90 to 99.8% by weight of 1,4-butanediol and gamma-butyrolactone, 2-methyl-1,4-butanediol, acetal and further secondary components such as pentanediols, hexanediols and heptanediols, and a fraction (7) which comprises organic high boilers and generally also comprises over 30% by weight of 1,4-butanediol. This is performed typically at a pressure (absolute) of from 0.005 to 0.8 bar, preferably between 0.001 and 0.5 bar, more preferably from 0.02 to 0.2 bar. The bottom fraction (7) is fed to a further column (V). Instead of column (III), it is also possible to use a falling-film evaporator or a thin-film evaporator.

Top fraction (6) is separated further by distillation in at least one further column (IV) into a top product (8), a bottom fraction (9) and a side stream (10). This further column (IV) is preferably at least one rectification column in the form of a tray column with sieve, bubble-cap, valve or tunnel-cap trays, or a packed column with random packings.

Top fraction (6) is separated in column (IV) into a top product (8) which comprises predominantly gamma-butyrolactone and 1,4-butanediol and also acetal, and a bottom product (9) which, as well as 1,4-butanediol, comprises 2-methylbutanediol, pentanediols, hexanediols and heptanediols. Very pure butanediol is obtained as the product (10) from the side draw of the column (IV). The side draw removal can be effected in liquid or gaseous form either in the rectifying section or in the stripping section or exactly in the middle of the column. Column (IV) has a number of theoretical plates between 30 and 200, preferably from 50 to 150. The pressure range of the column (top pressure) will preferably be between 5 and 500 mbar (absolute). From 20 to 250 mbar are particularly preferred. Depending on the top pressure and product composition, the temperatures in the column are established correspondingly.

In a particular embodiment, column (IV) may be a dividing wall column in which top fraction (6) is introduced into the column on one side of the dividing wall, while pure 1,4-butanediol (10) is drawn off on the other side of the dividing wall. In addition, combinations of at least one, preferably two, of the aforementioned rectification columns with a dividing wall column as column (IV) are possible.

In accordance with the invention, it has been recognized that, for successful purification of the 1,4-butanediol in the column (IV), the column is operated as far as possible without the introduction of oxygen. In combination with elevated temperatures, oxygen leads to products which severely disrupt the purity of the 1,4-butanediol. These components form in the presence of oxygen in the column, for example in the bottom of the column, and will migrate upward in the column as low boilers, in which case they automatically get into the pure 1,4-butanediol. These components are, for example, gamma-butyrolactone, 4-hydroxybutyraldehyde or its cyclic hemiacetal or the acetal. It is therefore preferred that the molar ratio of oxygen to 1,4-butanediol in the column does not exceed 1:500. The ratio is preferably below 1:1000, more preferably below 1:1500.

These ratios are achieved in the design and operation of the column by ensuring particularly that there are no leaks. For example, this is achieved by welding flanges or sealing them to an exceptional standard in another way.

The amount of the oxygen which is introduced into the column can be determined, for example, before the feed stream is put into operation by measuring the amount of the offgas stream and its oxygen content downstream of the vacuum unit in each of the vacuum columns (III, IV, V), for example by gas chromatography. During the operation of the column, it should be noted that the oxygen content might be indicated as too low, since oxygen can actually be depleted by reaction under these conditions. An important indication in this context can be given by the ratio of oxygen to nitrogen, which should of course correspond to that of the ambient air. A further means of determining the oxygen content is to evacuate the column without product feed, to isolate the column from the vacuum unit by closing a valve and to observe the rise in the pressure per unit time in the column. With knowledge of the column volume, this easily allows the amount of oxygen ingress per unit time to be determined.

A mixture (8) consisting of predominantly gamma-butyrolactone with 1,4-butanediol and further, quantitatively insignificant components is drawn off via the top of the column (IV). This top product can be recycled completely or partly into the hydrogenation, where the gamma-butyrolactone present can serve to regulate the pH. However, it is also possible to send the top product to incineration. Preference is given to recycling this top stream into the hydrogenation stage.

The bottom stream (9) of column (IV) comprises low-purity 1,4-butanediol and further products such as 2-methyl-1,4-butanediol, pentanediols, hexanediols and heptanediols and also quantitatively insignificant components, and is conducted completely or partly, preferably completely, into column (V).

The bottom stream (9) of the second column, together with the bottom stream (7) of column (III) is divided in column (V) into a high-boiling bottom product (12) which comprises 1,4-butanediol, high boilers and salts, and a product stream (11) comprising low-purity 1,4-butanediol. The product stream (11) is incinerated partly or in its entirety, or preferably recycled into column (III). The high-boiling bottom product (12) can be separated, for example, in a falling-film or thin-film evaporator at pressures of from 0.005 to 1 bar, preferably from 0.01 to 0.7 bar, more preferably from 0.02 to 0.4 bar, into high boilers and nonvolatile organic constituents such as pentanediols, hexanediols, heptanediols and salts, and a 1,4-butanediol-comprising stream. This 1,4-butanediol-comprising stream can be recycled mixed with the crude 1,4-butanediol (1), the product stream (5) or the bottom fraction (7) into the inventive distillative purification of 1,4-butanediol. According to the invention, the vacuum units can be operated with different media, for example water. It has been found to be advantageous to operate them with 1,4-butanediol.

The very pure 1,4-butanediol obtained by the above process variants usually has purities of >99.5%, typically >99.8%. The significant accompanying component is still 2-methyl-1,4-butanediol; the acetal, which is particularly undesired as a monoalcohol, generally lies below 0.1%, usually below 0.07%.

1,4-Butanediol finds use in industry in large amounts, for example in THF preparation or as a diol component in polyesters.

### EXAMPLES

### Quantitative Determination of the Products

The analyses of the products were undertaken by gas chromatography and are GC area percentages for the pure products.

### Example 1

### 1,4-Butanediol Preparation

In a reactor battery consisting of 3 cylindrical 10 m-long reactors with a diameter of 15 cm, filled with a catalyst (approx. 15% CuO, approx. 4% Bi₂O3 on SiO₂) in the form of 0.5-2 mm spall, prepared according to DE-A 26 02 418, which was operated both with cycle gas and with liquid circulation in upward mode (circulation to feed 10:1), 20 kg 32% aqueous formaldehyde and 2.8 kg/h of acetylene were reacted at 5 bar and from 70 to 90° C. at a pH of 6. The reaction product of the first reactor was conveyed into the second reactor and that of the second reactor into the third reactor. In this way, >95% of the formaldehyde and of the acetylene were converted to 1,4-butynediol. The pH of the reaction was controlled such that the pH was measured downstream of each reactor and, if required, small amounts of 1% aqueous NaOH solution were metered in. The reaction effluent of the third reactor was separated into gas and liquid phase in a separator. The liquid phase comprised approx. 50% by weight of butynediol, 1.3% by weight of propynol, 0.5% by weight of formaldehyde, 0.5% by weight of methanol, dissolved acetylene and several 100 ppm of nonvolatile oligomers, polymers and catalyst constituents, and also <0.5% other impurities and water. The gas phase, which comprised essentially acetylene, was recycled predominantly as cycle gas; 1% of the gas stream was discharged. The liquid effluent of the separator was passed into a column in which water, formaldehyde, methanol and propynol were removed (approx. 1 kg) via the top at 0.2 bar absolute and bottom temperature 90° C., and recycled into the reaction.

The bottom effluent was passed continuously into an intermediate buffer in which the mean residence time was 10 h at 60° C. and 1 bar (absolute). The butynediol-containing solution was withdrawn from this intermediate buffer and hydrogenated in a two-stage reactor battery with hydrogen over an Ni catalyst according to EP-A 394 841 in the form of 3×3 mm tablets (approx. 38% by weight of Ni, approx. 12% by weight of Cu on ZrO2/MoO3). The molar ratio of fresh hydrogen to 1,4-butynediol was 2.1:1. The first hydrogenation reactor (length 10 m, diameter 10 cm) was operated with liquid circulation for cooling in upward mode at reactor inlet pressure 250 bar and 120-140° C. To adjust the pH to approx. 7.2, 1% aqueous NaOH or gamma-butyrolactone was metered into the feed. The second reactor (length 10 m, diameter 5 cm) was operated in trickle mode of 140-160 to 140 to 175° C. at 250 bar. The effluent was separated in a separator into liquid phase and gas phase, and the gas phase was recycled by means of a cycle gas compressor.

In the outlet of the second reactor, (calculated without water) approx. 94.2% 1,4-butanediol, 0.04% gamma-butyrolactone, 0.06% 2-methyl-1,4-butanediol, 1.6% methanol, 2.5% n-propanol, 1.2% n-butanol, 0.04% acetal and a multitude of quantitatively minor components were found.

### Purification

Subsequently, the degassed hydrogenation effluent was separated into the individual constituents in a battery of five columns. In a first column (I), low boilers such as methanol, propanol and n-butanol were removed via the top together with water at approx. 5 bar and a bottom temperature of approx. 170° C. and sent to incineration. The bottom stream passed into a second column (II) in which quite predominantly water was distilled off via the top at approx. 0.3 bar and bottom temperature approx. 130° C.

The bottom stream of the second column (II) was separated in a third column (III) at approx. 0.15 bar and bottom temperature approx. 175° C. such that predominantly 1,4-butanediol together with gamma-butyrolactone, 2-methyl-1,4-butanediol, acetal, pentanediols, hexanediols, heptanediols and a few other, quantitatively insignificant components were distilled off via the top (6). This top stream was separated in a fourth column (IV) which was operated at approx. 0.04 bar and bottom temperature approx. 165° C. and a molar ratio of oxygen to 1,4-butanediol below 1:1000 into a top stream which, as well as 1,4-butanediol, comprised predominantly gamma-butyrolactone and acetal, a side stream (10) which consisted of very pure 1,4-butanediol (99.90% 1,4-butanediol, 0.05% 2-methyl-1,4-butanediol, 0.04% acetal) and a bottom stream which likewise consisted of predominantly 1,4-butanediol and was fed into the bottom stream of the third column (III). The bottom stream of the third column (Ill), together with that of the fourth column (IV), was separated in a fifth column (V) at approx. 0.05 bar and bottom temperature 170° C. such that the top stream (11) which comprised predominantly 1,4-butanediol was recycled into the feed of the third column, while the bottom stream (12) which, as well as a small amount of 1,4-butanediol, comprised high boilers and salts was discharged and incinerated.

### Comparative example

Example 1 was repeated, with the difference that the pure 1,4-butanediol was obtained as the bottom product of column (4) in accordance with DE-A 2 055 892. The purity of this 1,4-butanediol was 99.75%, 0.07% 2-methyl-1,4-butanediol, 0.04% acetal, 0.1% pentanediols, hexanediols and heptanediols together at 0.02%.

1. A process for distillatively purifying crude aqueous 1,4-butanediol, in which 1,4-butanediol freed of components having lower boiling points than 1,4-butanediol and water is passed through three distillation columns, components having a higher boiling point than 1,4-butanediol are drawn off from the bottom of the first column and conducted into the third, 1,4-butanediol from the top of the first column is conducted into the second column, the bottom product of the second column is conducted into the third, the top product of the third column is recycled at least partly into the first column, wherein the very pure 1,4-butanediol is withdrawn from a side draw of the second column.

2. The process according to claim 1, wherein the 1,4-butanediol obtained in the third column is recycled into the distillation together with the feed of the first column.

3. The process according to claim 1, wherein the molar ratio of oxygen to 1,4-butanediol in the second column is less than 1:500.

4. The process according to claim 2, wherein the molar ratio of oxygen to 1,4-butanediol in the second column is less than 1:500.
